(19) United States
(12) Patent Application Publication
(10) Pub. No.: US 2026/0123616 A1
(43) Pub. Date: May 7, 2026

(54) MULTI-BAIT RIG

(71) Applicant: Pure Fishing, Inc., Spirit Lake, IA (US)

(72) Inventors: Kyle Jacob PETERSON, Spirit Lake, IA (US); Jordan KIMBROUGH, El Paso, IL (US)

(21) Appl. No.: 19/381,221

(22) Filed: Nov. 6, 2025

Related U.S. Application Data
(60) Provisional application No. 63/717,137, filed on Nov. 6, 2024.

(51) Int. Cl. A01K 91/04

(52) U.S. Cl. CPC A01K 91/04

(57) ABSTRACT

The present disclosure is directed to a rig for attaching one or more lures to a fishing line. The rig may include a rig body having a main channel configured to receive a portion of the fishing line and at least one leader channel configured to receive at least a portion of at least one leader. The at least one leader may be designed to retain the one or more lures. The rig may also include an insert configured to be at least partially received within the main channel and designed to restrict movement of the rig body relative to the fishing line when the rig is in use. Engagement between the rig body and the insert may apply a pinching force to the fishing line.

### CROSS-REFERENCE TO RELATED APPLICATIONS

This application claims priority under 35 U.S.C. § 119 to U.S. Provisional Application No. 63/717,137, filed Nov. 6, 2024, the entirety of which is hereby incorporated by reference.

### FIELD OF INVENTION

The present disclosure relates to fishing tackles, in particular, to a multi-bait rig.

### BACKGROUND OF INVENTION

In the fishing world, the term “tackle” is used by anglers to refer to equipment used to catch fish (e.g., rods, reels, line, hooks, etc.). For example, in some cases, anglers use artificial “lures,” or attachments that mimic the appearance and movement of prey, to attract and entice fish. Traditionally, lures are attached to the fishing line by threading a piece of line through an eyelet of the lure and tying the piece of line to the fishing line via a knot. Additionally, multi-bait rigs are used to attach multiple lures to the fishing line to produce a “schooling presentation” that mimics the appearance of schooling fish. However, multi-bait rigs also tend to be attached to the fishing line by tying a knot. Thus, it can be difficult and time-consuming to attach lures to the fishing line and to reposition said lures on the fishing line once a knot has already been tied (e.g., the knot must be untied and the lure must be repositioned before retying the knot). To address these and other challenges, a need exists that would enable the convenient and efficient attachment, detachment, and repositioning of lures on a fishing line.

### SUMMARY OF INVENTION

The present disclosure is directed to a rig that can be utilized to attach one or more lures to a fishing line without the use of knots. Additionally, the rig disclosed herein may enable users to efficiently reposition the lures at a desired location along the fishing line. The rig may be configured to engage (e.g., apply a pinching force or a friction to) the fishing line such that the rig is restricted from moving or shifting undesirably relative to the fishing line while in use. For example, the rig may include a rig body with a channel designed to receive a portion of the fishing line and with one or more channels designed to receive a portion of one or more leaders, each of the leaders supporting one or more bait keepers to which lures or pieces of bait can be attached.

The channel that receives the fishing line may be configured to engage the fishing line such that it is restricted from undesirably moving or shifting while the rig is in use. For example, the rig body may engage the fishing line by applying a pinching force or a friction thereto. In some embodiments, an adjustable component (e.g., a cap, insert, roller, or other component) may be provided to facilitate engagement between the rig body and the fishing line. However, in other embodiments, the rig body may engage the fishing line without help from another component. Additionally, in some embodiments, a tube may be provided to surround the fishing line (e.g., to facilitate engagement with the rig body). However, in other embodiments, the tube may be omitted. The rig body may be removably couplable to or installable on the fishing line such that a user can easily reposition the rig at a different location along the fishing line.

These and other aspects and advantages of the present invention will become apparent to those skilled in the art after considering the following detailed description in connection with the accompanying drawings.

### BRIEF DESCRIPTION OF THE DRAWINGS

FIG. 1 is a perspective view of an exemplary rig constructed according to the principles of the present disclosure.

FIG. 2 is a perspective view of a rig body of the rig of FIG. 1.

FIG. 3 is a cross-sectional view of an exemplary cap of the rig of FIG. 1.

FIG. 4 is a perspective view of another exemplary cap of the rig of FIG. 1.

FIG. 5 is an enlarged perspective view of a portion of the rig of FIG. 1 in a partially assembled state.

FIG. 6 is a perspective view of the rig of FIG. 1 in a fully assembled state.

FIG. 7 is an enlarged cross-sectional view of the rig of FIG. 1 taken along the line 7-7 of FIG. 6.

FIG. 8 is a perspective view of the rig of FIG. 1 with lures attached thereto.

FIG. 9 is a perspective view of another exemplary rig constructed according to the principles of the present disclosure.

FIG. 10 is a perspective view of a rig body of the rig of FIG. 9.

FIG. 11 is a perspective view of a roller of the rig body of FIG. 10.

FIG. 12 is a perspective, cross-sectional view of the rig body of FIG. 10 taken along the line 12-12 of FIG. 10.

FIG. 13 is an enlarged perspective view of the rig of FIG. 9.

FIG. 14 is a perspective view of an additional exemplary rig constructed according to the principles of the present disclosure.

FIG. 15 is a perspective view of a rig body of the rig of FIG. 14.

FIG. 16 is a top perspective view of the rig body of FIG. 15.

FIG. 17 is a perspective view of a rig insert of the rig of FIG. 14.

FIG. 18 is a perspective view of the rig insert of FIG. 17 installed on the rig body of FIG. 15.

FIG. 19 is a cross-sectional view of the rig insert of FIG. 17 installed on the rig body of FIG. 15 taken along the line 19-19 of FIG. 18.

FIG. 20 is a perspective view of a rig body and a rig insert of a further exemplary rig constructed according to the principles of the present disclosure.

FIG. 21 is a perspective view of the rig body of FIG. 20 in a disassembled state and the rig insert of FIG. 20 positioned adjacent thereto.

FIG. 22 is a top perspective view of the rig body and rig insert of FIG. 20.

FIG. 23 is a bottom perspective view of the rig insert of FIG. 20 installed on the rig body of FIG. 20.

FIG. 24 is a perspective view of yet another exemplary rig constructed according to the principles of the present disclosure.

FIG. 25 is a perspective view of a rig body of the rig of FIG. 24 in a closed position.

FIG. 26 is an additional perspective view of the rig body of FIG. 25.

FIG. 27 is a perspective view of the rig body of FIG. 25 in an open position.

While the disclosure is susceptible to various modifications and alternative forms, one or more specific embodiments thereof are shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The following description refers to the drawing figures, in which like reference numerals refer to like parts throughout. For purposes of clarity in illustrating the exemplary embodiments described herein, proportional relationships of the elements have not necessarily been maintained in the drawing figures.

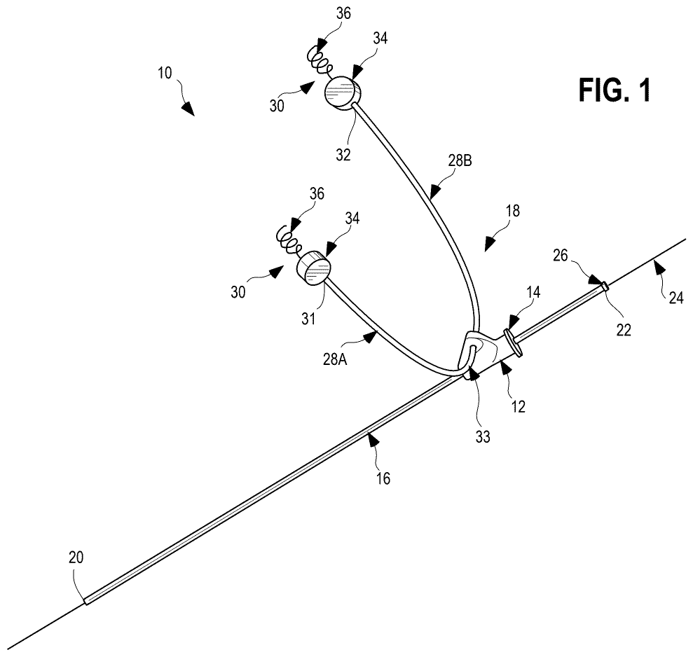

Referring first to FIG. 1, a rig 10 may include a rig body 12, an engagement mechanism such as an insert (e.g., a cap 14) designed to be releasably couplable with the rig body 12, a tube 16, and one or more leaders 18. For example, the rig body 12 may receive at least a portion of the tube 16 and/or at least a portion of one or more leaders 18 when the rig 10 is assembled, and the insert or the cap 14 may be configured to secure the rig 10 in place (or to reduce the likelihood that the rig 10 will move or shift undesirably while in use by restricting movement of the rig body 12 relative to the tube 16).

The tube 16 may be provided in the form of a substantially tubular body defined by a tube first end 20 and a tube second end 22 opposing the tube first end 20. The tube 16 may be substantially hollow and configured to receive a fishing line 24 extending therethrough. For example, the tube 16 may facilitate mounting or installation of the rig body 12 on the fishing line 24. In some embodiments, at least a portion of the tube 16 may be coupled to the rig body 12 (e.g., glued thereto, formed integrally therewith, etc.) when the rig 10 is assembled. In other embodiments, the tube 16 may be removably positioned within the rig body 12.

The rig body 12 and cap 14 may each be positioned along the tube 16, and the cap 14 may be couplable to the rig body 12 to secure the rig 10 in place (e.g., by engaging the rig body 12, the tube 16, and/or the fishing line 24). The cap 14 may prevent or restrict the rig body 12 from moving with respect to the tube 16 and/or may prevent or restrict the rig 10 from moving with respect to the fishing line 24 when the rig 10 is in use. The tube 16 may include a flared end 26 (e.g., at the tube second end 22) configured to restrict or prevent the tube 16 from being pulled through the cap 14 or the cap 14 from being unintentionally ejected from the tube 16.

Thus, the cap 14 may function as an engagement mechanism that facilitates engagement between the rig body 12, the tube 16, and/or the fishing line 24 to restrict movement of the rig body 12 while the rig 10 is in use. However, in other instances, the rig 10 may include an engagement mechanism provided in other suitable forms (e.g., a roller 150, a rig insert 214, a rig insert 314, one or more grip members 490, or other forms not specifically described herein), as described in further detail below. These engagement mechanisms may be actuated to apply a pinching force (or other force) to the tube 16 and/or the fishing line 24 in various ways. In the example of the cap 14, the engagement mechanism may be actuated by coupling the cap 14 to the rig body 12. However, in other embodiments, the engagement mechanism may be actuated to apply a force to the tube 16 and/or the fishing line 24 in other suitable manners.

In some embodiments, the leader 18 may include one or more arms 28 each configured to support one or more bait keepers 30. In the example of FIG. 1, the leader 18 may be provided in the form of a substantially tubular body defined by a leader first end 31 and a leader second end 32. The leader 18 may include a first arm 28A proximate to the leader first end 31 and a second arm 28B proximate to the leader second end 32. The bait keepers 30 may be coupled to the first and second arms 28A, 28B at the leader first end 31 and the leader second end 32, respectively. In some embodiments, the bait keepers 30 may be provided in substantially the same form; however, the bait keepers 30 may also be provided in different forms. Additionally, while the arms 28 of the illustrated embodiment each support one bait keeper 30, in other embodiments, each arm 28 may support multiple bait keepers 30.

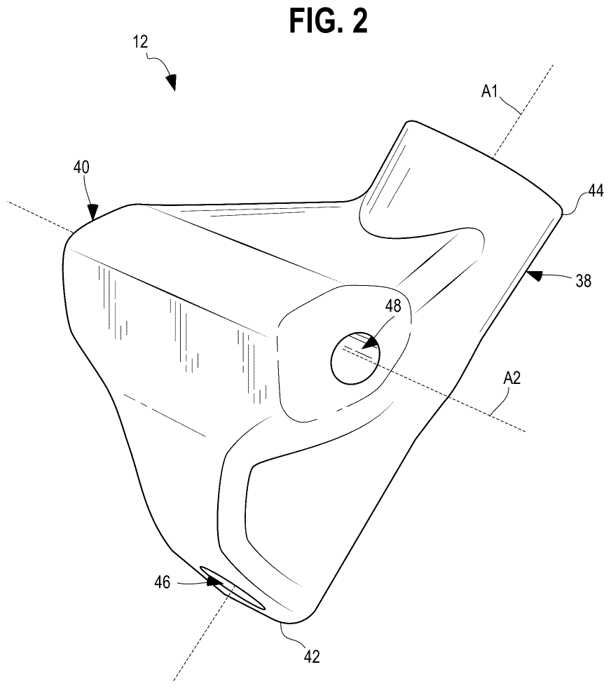

In the example of FIG. 1, the leader 18 includes two arms 28 and a midsection 33 positioned therebetween and configured to be received within an opening in the rig body 12 (as described in further detail below with reference to FIG. 2). In other embodiments, the leader 18 may include any number of arms 28 supporting any number of bait keepers 30. For example, the leader 18 may include four arms 28, six arms 28, eight arms 28, or any other suitable number of arms 28. The arms 28 of the leader 18 may be arranged in any suitable configuration (e.g., each arm 28 may emanate from the midsection 33, one or more arms 28 may emanate from one or more other arms 28, etc.). Moreover, while the example of FIG. 1 includes a single leader 18, the rig 10 may include any number of leaders 18 positioned in any suitable arrangement.

The bait keepers 30 may each be configured to receive and retain a piece of bait (e.g., a worm, cricket, minnow, or other piece of live or dead bait) or a lure. For example, in the illustrated embodiment, each bait keeper 30 includes a tab 34 coupled to the leader 18 and an attachment member 36 coupled to the tab 34 and extending outwardly therefrom. In some embodiments, the attachment member 36 may be a corkscrew-shaped attachment member such as a twist lock or spring lock. However, in other embodiments, the attachment member 36 may be provided in other forms. The bait or lure can be coupled to the bait keeper 30 via the attachment member 36. However, in other embodiments, the bait keepers 30 may be provided in other forms and may include additional or alternative components (e.g., barbs, wire wraps, plastic collars, and the like) configured to receive and retain a bait or lure.

Turning to FIG. 2, the rig body 12 may generally include a substantially cylindrical portion 38 and a substantially triangular protruding portion 40. The cylindrical portion 38 and the protruding portion 40 may be coupled together or may be formed integrally with one another. The cylindrical portion 38 may extend between a rig body first end 42 and a rig body second end 44 opposing the rig body first end 42.

The cylindrical portion 38 may be configured to receive a portion of the tube 16 and/or the fishing line 24, and the protruding portion 40 may be configured to receive a portion of the leader 18 (e.g., the midsection 33) when the rig 10 is assembled. For example, a main channel 46 designed to receive a portion of the tube 16 and/or a portion of the fishing line 24 may extend through the cylindrical portion 38, and at least one leader channel 48 designed to receive a portion of the leader 18 may extend through the protruding portion 40. In some cases, the main channel 46 and the leader channel 48 may each be provided in the form of a substantially cylindrical opening extending entirely through the cylindrical portion 38 and the protruding portion 40, respectively. The main channel 46 may be oriented along a first axis A1, and the leader channel 48 may be oriented along a second axis A2. In some embodiments, the first and second axes A1, A2 may be oriented at an angle with respect to one another or may be substantially perpendicular with respect to one another. In other embodiments, however, the main channel 46 and the leader channel 48 may be positioned and oriented in any suitable manner.

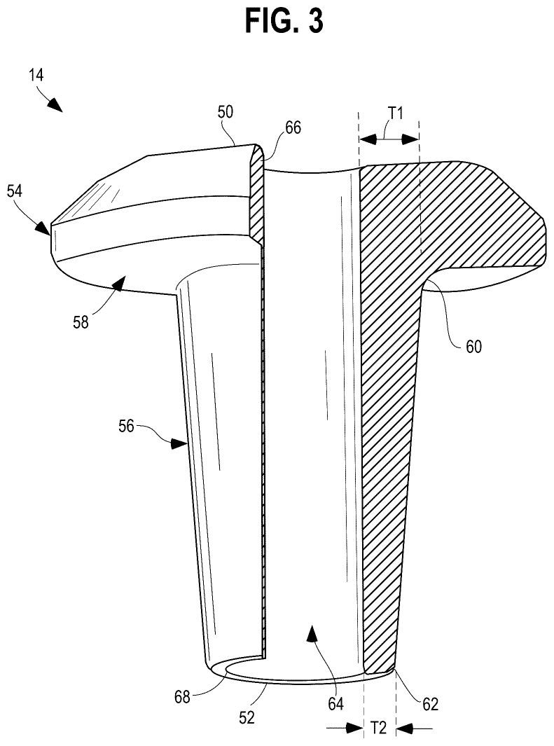

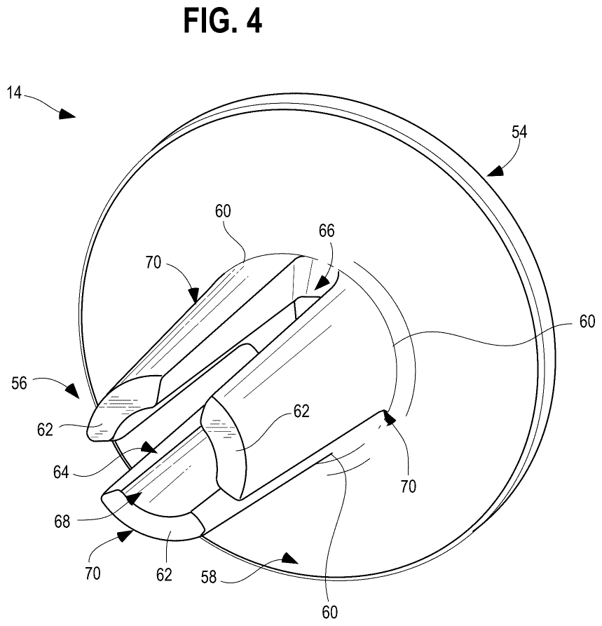

Turning to cross-sectional view of FIG. 3, in some embodiments, the cap 14 may have a cap first end 50 and a cap second end 52 opposing the cap first end 50. The cap 14 may include a cap body 54 positioned at or proximate to the cap first end 50 and a cap insert 56 extending between the cap body 54 and the cap second end 52. The cap insert 56 may be formed integrally with the cap body 54, or the cap insert 56 may be coupled to a lower surface 58 of the cap body 54 and extend downwardly therefrom. For example, in some embodiments, the cap insert 56 may be provided in the form of a substantially annular protrusion including an insert proximal end 60 coupled to the cap body 54 and an insert distal end 62 opposing the insert proximal end 60 (e.g., corresponding to the cap second end 52). In other embodiments, such as the example shown in FIG. 4, the cap insert 56 may be provided in other forms and may include multiple segments rather than being provided as a unitary structure. The cap 14 may be configured to facilitate engagement between the rig body 12 and the tube 16, and the cap insert 56 may be configured to be received within the main channel 46 of the rig body 12.

The cap 14 may include a cap channel 64 provided in the form of a substantially circular opening extending between the cap first end 50 and the cap second end 52 (e.g., extending entirely through the cap body 54 and the cap insert 56). The cap 14 may include a first cap opening 66 positioned at or proximate to the cap first end 50 and a second cap opening 68 positioned at or proximate to the cap second end 52, and the first and second cap openings 66, 68 may be in communication with the cap channel 64.

In some embodiments, the cap insert 56 may have a tapered geometry (e.g., to facilitate coupling between the rig body 12 and the cap 14). For example, the cap insert 56 may be defined by a first thickness T1 at or near the insert proximal end 60 and a second thickness T2 at or near the insert distal end 62. The thickness of the cap insert 56 may decrease from the first thickness T1 to the second thickness T2 along the length of the cap insert 56 (e.g., moving from the insert proximal end 60 to the insert distal end 62). In other embodiments, however, the cap insert 56 may have any suitable shape or structure.

For example, in the embodiment of FIG. 4, the cap insert 56 may be provided in the form of one or more insert segments 70. For example, the cap insert 56 may include three insert segments 70 that substantially surround and define the cap channel 64. Each of the insert segments 70 may extend between the insert proximal end 60 and the insert distal end 62, and the insert segments 70 may be coupled to the cap body 54 at the insert proximal end 60. In some embodiments, the insert segments 70 may be tapered as described above with reference to FIG. 3.

Additionally (or alternatively), the insert segments 70 may be flexibly coupled to the cap body 54 at the insert proximal end 60 such that each insert segment 70 is configured to flex or pivot inwardly and/or outwardly about the insert proximal end 60. In this way, the size or diameter of the cap channel 64 (e.g., proximate to the insert distal end 62) may vary depending on the state or position of the insert segments 70. For example, if the insert segments 70 flex inwardly, the size or diameter of the cap channel 64 proximate to the insert distal end 62 may be reduced. In other embodiments, the cap insert 56 may include more or fewer than three insert segments 70, or the cap insert 56 may be provided in other forms.

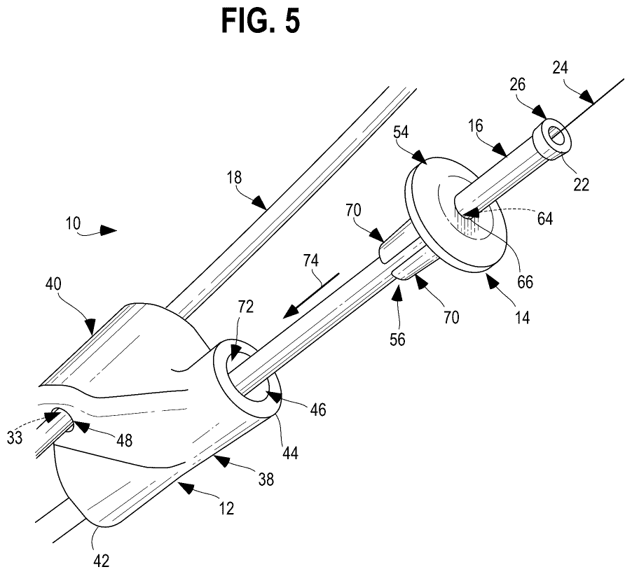

Turning to FIG. 5, the rig 10 is depicted in a partially assembled state. As shown, the fishing line 24 may be fed through the tube 16, and the rig body 12 and the cap 14 may be positioned along the tube 16 (e.g., such that the tube 16 extends through the main channel 46 of the rig body 12 and the cap channel 64 of the cap 14). Additionally, the leader 18 may extend through the leader channel 48 such that the midsection 33 (or another portion) of the leader 18 is positioned within the leader channel 48. In some embodiments, once positioned within the leader channel 48, the leader 18 may be fixedly coupled thereto using glue or any other suitable means of connection.

The cap 14 may be positioned between the rig body 12 and the flared end 26, and the cap 14 may be slidable on the tube 16 when the tube 16 extends through the cap channel 64 such that the position of the cap 14 with respect to the tube 16 can be adjusted. In some embodiments, a size or diameter of the first cap opening 66 may be smaller than a size or diameter of the flared end 26 of the tube 16 such that the tube second end 22 is restricted or prevented from traveling through the cap channel 64. Therefore, the flared end 26 may prevent the cap 14 from being unintentionally disengaged from the tube 16.

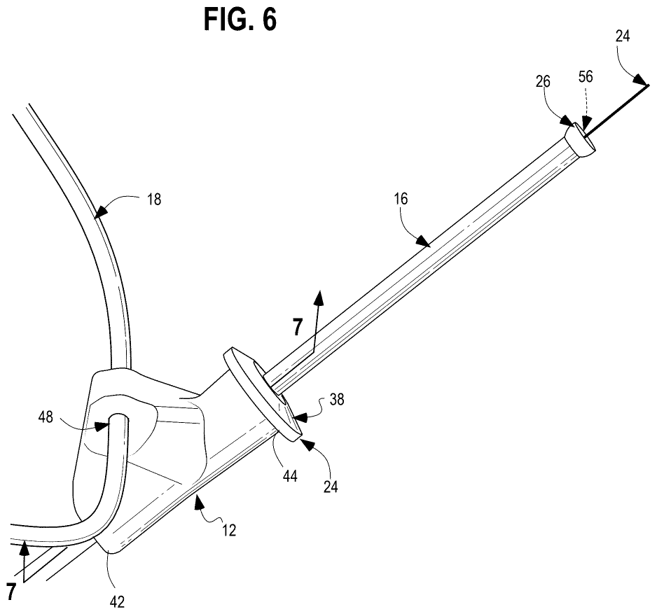

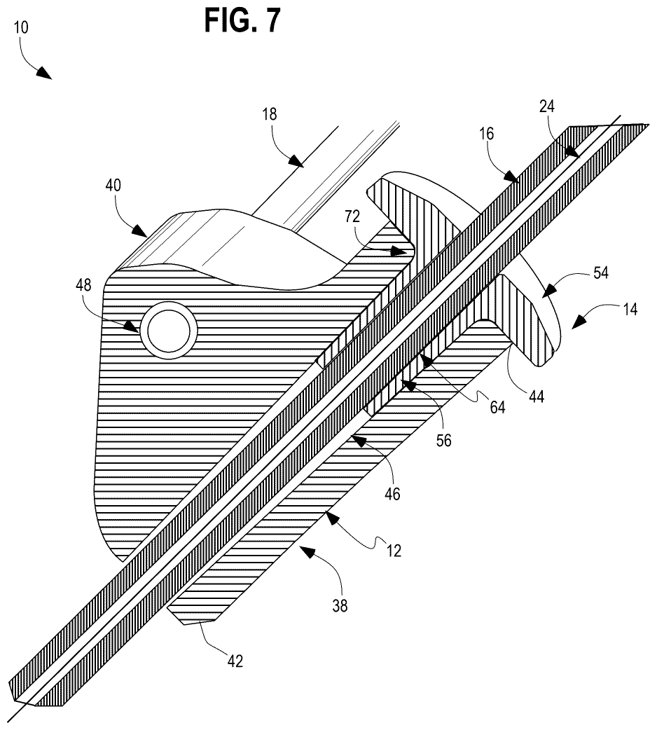

The rig body 12 may include a receiving opening 72 positioned at an end of the main channel 46 (e.g., positioned at or proximate to the rig body second end 44) and formed as an opening of the main channel 46. The receiving opening 72 may be configured to receive the cap insert 56. For example, to complete assembly of the rig 10, a user may move the cap 14 along the tube 16 in the direction of arrow 74 until the cap insert 56 is received within and/or engages the main channel 46. Thus, as shown in FIGS. 6 and 7, when the rig 10 is assembled, the cap insert 56 may extend through the receiving opening 72 and the cap body 54 may be in contact with or adjacent to the rig body second end 44. For example, the receiving opening 72 may be configured to receive the cap insert 56 in a press fit, snap fit, or friction fit. Alternatively, the cap 14 may be releasably coupled with the rig body 12 in any suitable manner.

As most clearly shown in FIG. 7, the main channel 46 may be configured to snugly receive the cap insert 56 regardless of whether the cap insert 56 is provided in the form of a cylindrical protrusion (see FIG. 3), one or more insert segments 70 (see FIG. 4), or another form. The cap insert 56 may be configured to apply a pinching force to the tube 16 and/or the fishing line 24 when the rig 10 is assembled. For example, the cap insert 56 may be constructed such that the cap insert 56 contacts the tube 16 and/or the fishing line 24 when the cap insert 56 extends into the main channel 46. In other embodiments, engagement between the cap insert 56 and the rig body 12 (e.g., an interior surface of the main channel 46) may cause the cap insert 56 to apply a pinching force to the tube 16 and/or the fishing line 24 such that the rig 10 is secured in place with respect to the tube 16 and/or the fishing line 24.

In some embodiments, at least a portion of the main channel 46 located proximate to the rig body second end 44 may be tapered (e.g., inversely tapered with respect to the cap insert 56). Thus, the main channel 46 may engage the cap insert 56 and apply an inward force thereto when the cap 14 is coupled to the rig body 12, thereby causing the cap insert 56 to apply a pinching force to the tube 16. The tube 16 may be formed from a flexible material such that the tube 16 is configured to yield to the inward force and contact (e.g., pinch) the fishing line 24. In embodiments where the cap insert 56 includes insert segments 70, the engagement between the main channel 46 and the insert segments 70 may cause the insert segments 70 to flex or pivot inwardly about the insert proximal end 60 (see FIG. 4) such that the insert segments 70 contact (e.g., pinch) the tube 16 and/or the fishing line 24. In other embodiments, the cap 14 and rig body 12 may be configured to engage one another in any suitable manner, provided that engagement between the cap 14 and rig body 12 secures the rig 10 in place with respect to the fishing line 24 (or limits the ability of the rig 10 to move undesirably along the fishing line 24).

In some embodiments, at least a portion of the main channel 46 is narrow enough to apply a pinching force to the tube 16 such that at least a portion of the tube 16 contacts the fishing line 24. For example, contact between the tube 16 and the fishing line 24 may apply a friction to the fishing line 24 that helps maintain the rig 10 in place with respect to the fishing line 24 while the rig 10 is in use.

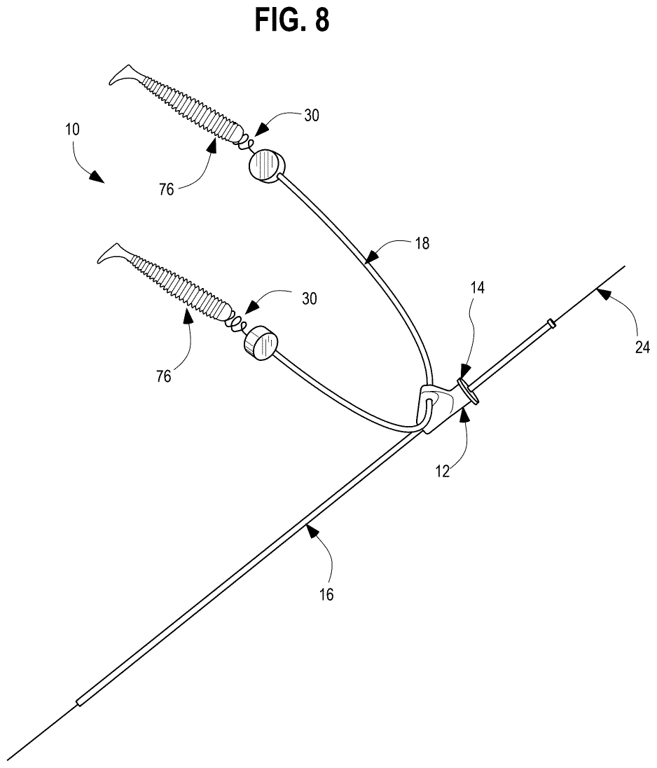

As shown in FIG. 8, with the rig 10 fully assembled, lures 76 may be attached to the bait keepers 30. If, during use, a user wishes to adjust the positioning of the rig 10 with respect to the tube 16 or the fishing line 24, the rig 10 can be adjusted by (1) decoupling the cap 14 from the rig body 12 (e.g., releasing the inward pressure applied to the tube 16), (2) moving the rig 10 to the desired position, and (3) recoupling the cap 14 and the rig body 12.

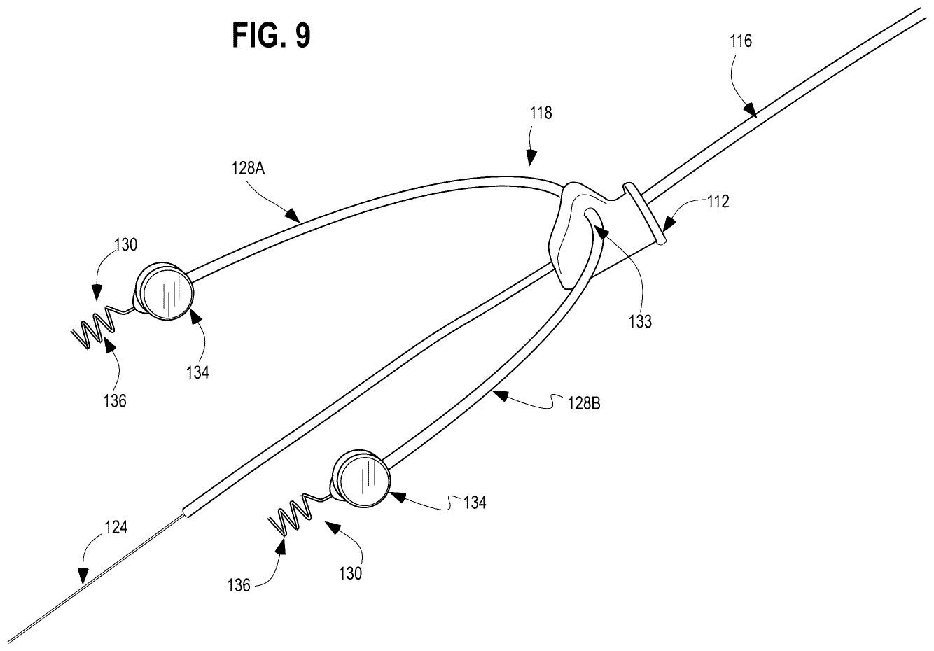

Turning to FIG. 9, a rig 110 may be substantially similar to the rig 10, except that the rig body 12 may be provided in a somewhat different form and the cap 14 may be omitted. Components of the rig 110 and the rig 10 that have similar names and reference numbers separated by exactly 100 may be substantially similar in form and function.

The rig 110 may include a rig body 112 that is configured to receive at least a portion of a tube 116 and/or at least a portion of one or more leaders 118. For example, the tube 116 may facilitate mounting or installation of the rig body 112 on a fishing line 124. The leader 118 may include one or more arms 128 supporting one or more bait keepers 130 and a midsection 133 arranged to be received within and/or coupled to an opening in the rig body 112. In the example of FIG. 9, the leader 118 may include a first and second arm 128A, 128B each supporting one bait keeper 130. In other embodiments, however, the leader 118 may include any number of arms 128 and any number of bait keepers 130 arranged in any suitable configuration. The bait keepers 130 may be substantially similar to the bait keepers 30 of the rig 10. For example, the bait keepers 130 may each include a tab 134 coupled to the leader 118 and an attachment member 136 coupled to the tab 134 and extending outwardly therefrom. However, in other embodiments, the bait keepers 130 may be provided in any suitable form.

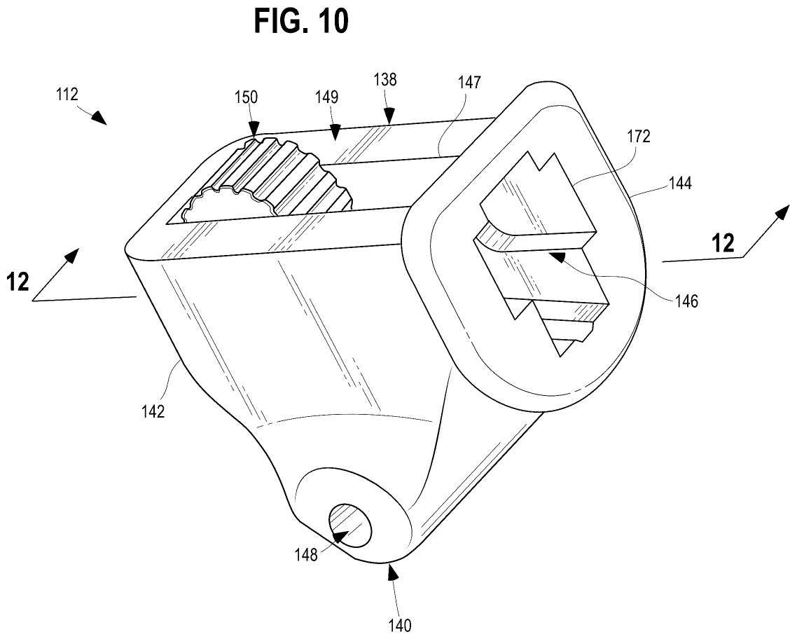

Turning to FIG. 10, the rig body 112 may include a substantially rectangular portion 138 and a substantially triangular protruding portion 140. The rectangular portion 138 may correspond to the cylindrical portion 38 of the rig body 12, although the rectangular portion 138 may be imparted with a substantially rectangular shape or another shape. The rectangular portion 138 may extend between a rig body first end 142 and a rig body second end 144 opposing the rig body first end 142.

The rectangular portion 138 may be configured to receive a portion of the tube 116 and/or the fishing line 124, and the protruding portion 140 may be configured to receive a portion of the leader 118 (e.g., the midsection 133) when the rig 110 is assembled. For example, a main channel 146 may extend through the rectangular portion 138 and a leader channel 148 may extend through the protruding portion 140. The leader channel 148 may be provided in substantially the same form as the leader channel 48 (e.g., the leader channel 148 may be provided in the form of a substantially cylindrical opening extending entirely through the protruding portion 140).

However, the main channel 146 may be provided in a somewhat different form relative to the main channel 46. For example, in some embodiments, the main channel 146 may be provided in the form of a substantially rectilinear opening extending entirely through the rectangular portion 138 (e.g., extending between the rig body first end 142 and the rig body second end 144). The rig body 112 may include a receiving opening 172 positioned at or proximate to the rig body second end 144 and in communication with the main channel 146. The receiving opening 172 may differ from the receiving opening 72 of the rig 10 in that the receiving opening 172 may be substantially rectilinear (e.g., T-shaped in the example of FIG. 10) and may be oversized with respect to the tube 116. For example, the tube 116 may have freedom to move or shift within the receiving opening 172 when the rig 110 is in use. The rig body 112 may also include an upper window 147 positioned on an upper face 149 of the rig body 112 and in communication with the main channel 146.

In some embodiments, a roller 150 may be at least partially positioned within the main channel 146 such that at least a portion of the roller 150 extends beyond the upper face 149 of the rig body 112. The roller 150 may perform a similar function as compared to the cap 14 of the rig 10. For example, the roller 150 may be configured to apply a pinching force to the tube 116 and/or the fishing line 124 such that the roller 150 prevents or restricts the rig body 112 from moving or shifting undesirably relative to the tube 116 and/or the fishing line 124 when the rig 110 is in use.

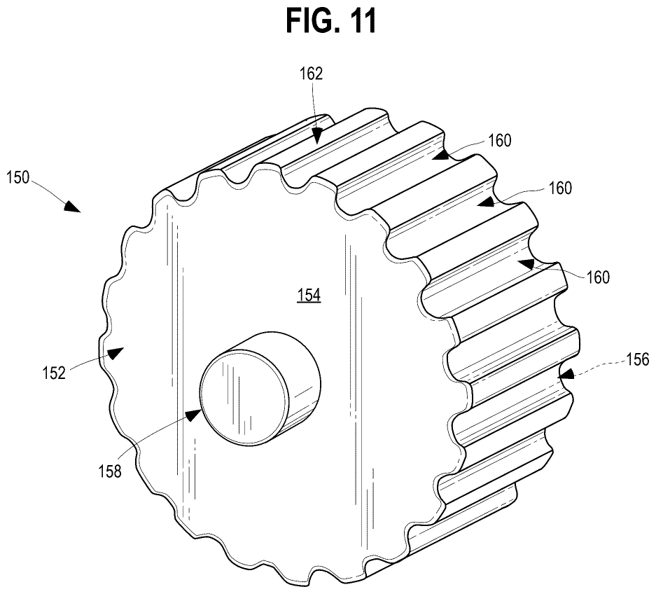

Turning to FIG. 11, the roller 150 may provided in the form of a substantially cylindrical roller body 152 defined by a first side face 154 and a second side face 156 opposing the first side face 154. The roller 150 may include a stud 158 positioned on the first side face 154 and extending outwardly therefrom. For example, in some instances, the stud 158 may be provided in the form of a substantially cylindrical protrusion positioned in a substantially central location with respect to the first side face 154. The roller body 152 may further include a plurality of notches 160 spaced radially apart from one another along an exterior surface 162 of the roller 150. For example, the plurality of notches 160 may aid a user in engaging or manipulating the roller 150 via the exterior surface 162 when the rig 110 is in use.

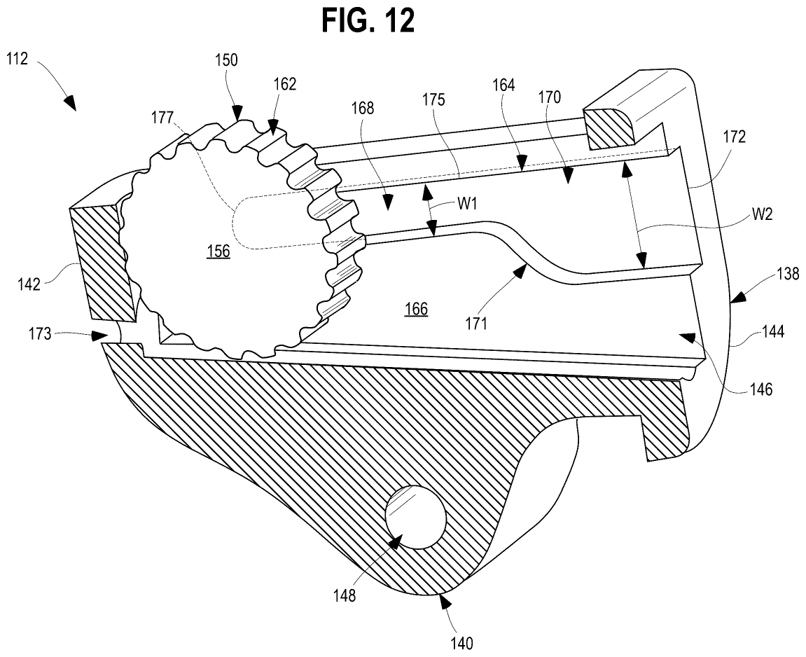

Turning to FIG. 12, the second side face 156 may be provided in the form of a substantially smooth or planar surface. The rig body 112 may also include a guide track 164 positioned within the main channel 146 and configured to receive the stud 158 or another portion of the roller 150. The guide track 164 may be provided in the form of a substantially linear carveout positioned on a main channel interior surface 166 and extending from the rig body second end 144 at least partially toward the rig body first end 142. The guide track 164 may include a first guide track portion 168 configured to engage the stud 158 and a second guide track portion 170 positioned between the first guide track portion 168 and the rig body second end 144.

In some embodiments, the guide track 164 may be wider or larger at the second guide track portion 170 than at the first guide track portion 168. For example, the first guide track portion 168 may be defined by a first width W1 and the second guide track portion 170 may be defined by a second width W2 greater than the first width W1. In some embodiments, the guide track 164 may include a taper region 171 positioned between the first guide track portion 168 and the second guide track portion 170. For example, the width of the guide track 164 may taper from the first width W1 to the second width W2 across the taper region 171.

In some embodiments, the first guide track portion 168 may be configured to receive and engage the stud 158 of the roller 150. For example, the first width W1 may be substantially equal to (or slightly less or greater than) the width or diameter of the stud 158. Thus, when the stud 158 is received within the first guide track portion 168, the stud 158 may contact an interior surface of the first guide track portion 168 such that a friction is created therebetween. In this way, the first guide track portion 168 may be configured to retain the roller 150 in a fixed position relative to the guide track 164 when the rig 110 is in use. For example, in order to adjust the position of the roller 150 relative to the guide track 164, a user may manually engage the exterior surface 162 of the roller 150 (e.g., to roll the roller 150 along the guide track 164). In other words, the roller 150 may be manually adjustable within the guide track 164. In this way, adjusting the position of the roller 150 by moving the roller 150 within the guide track 164 may enable a user to manipulate (e.g., increase or decrease) the pinching force applied by the roller 150 to the tube 116 and/or the fishing line 124.

The rig body 112 may also include an exit opening 173 in communication with the main channel 146 and positioned opposite the receiving opening 172 (e.g., the exit opening 173 may be positioned at or proximate to the rig body first end 142). Unlike the receiving opening 172, the exit opening 173 may have a width or diameter that is substantially equal to (or somewhat larger than) the width or diameter of the tube 116. For example, the tube 116 may have less freedom to move within the exit opening 173 than within the receiving opening 172 when the rig 110 is in use.

The first guide track portion 168 may extend between a first guide track portion proximal end 175 positioned at or adjacent to the taper region 171 and a first guide track portion terminal end 177 positioned proximate to the rig body first end 142. Additionally, the main channel 146 may include a main channel base 179 extending between the receiving opening 172 and the exit opening 173. For example, at least a portion of the tube 116 may rest against or be positioned adjacent to the main channel base 179 when the rig 110 is in use.

The first guide track portion 168 may be oriented at an angle with respect to the main channel base 179 such that a distance between the first guide track portion proximal end 175 and the main channel base 179 is greater than a distance between the first guide track portion terminal end 177 and the main channel base 179. As a result, the roller 150 may contact the tube 116 and apply a pinching force to the tube 116 and/or the fishing line 124 as the roller 150 moves from the first guide track portion proximal end 175 toward the first guide track portion terminal end 177. In this way, a user may operate the roller 150 to secure the rig body 112 in place with respect to the tube 116 and/or the fishing line 124.

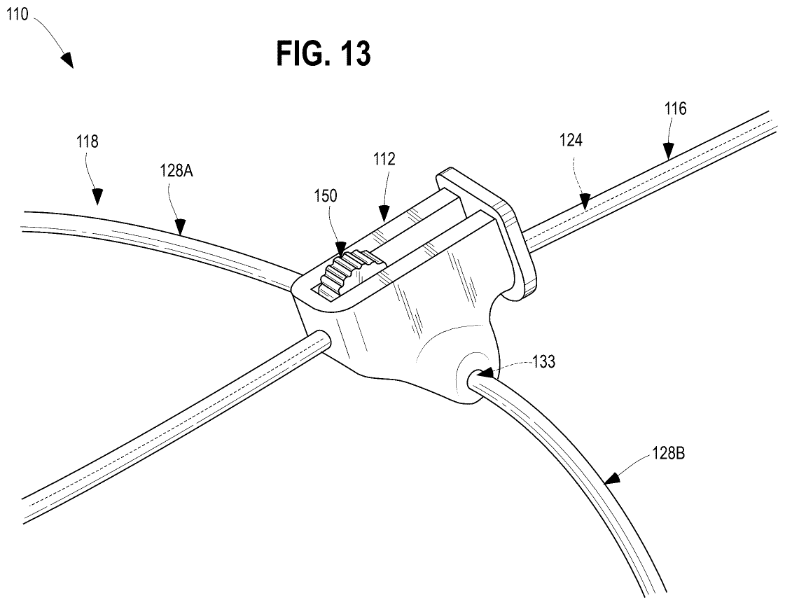

FIG. 13 depicts the rig 110 in an assembled state. As shown, the tube 116 may extend through the main channel 146 and the leader 118 may extend through the leader channel 148. As shown in FIG. 13, the roller 150 is positioned at or proximate to the first guide track portion terminal end 177. Therefore, the roller 150 may be in contact with the tube 116 and be arranged to apply a pinching force thereto, thereby reducing the likelihood that the rig 110 (e.g., the rig body 112) will unintentionally move or shift while the rig 110 is in use.

Although the above description pertains to use of the rig 110 with the tube 116 surrounding the fishing line 124, the rig 110 may also be used without the tube 116. For example, the fishing line 124 alone may be fed through the main channel 146, and the roller 150 may be configured to apply a pinching force to the fishing line 124 in substantially the same manner as described above.

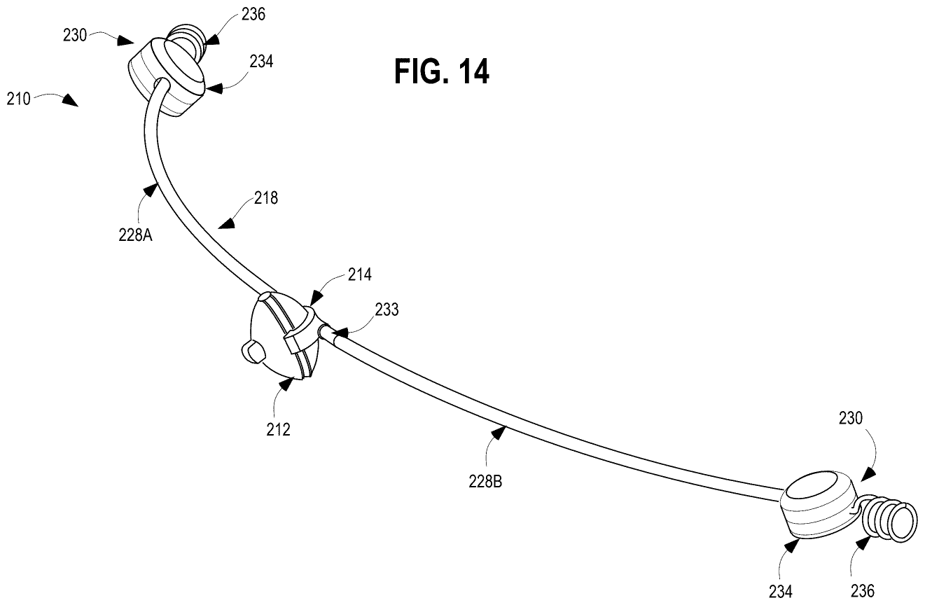

Turning to FIG. 14, a rig 210 may be substantially similar to the rig 10, and components of the rig 210 and components of the rig 10 that have similar names and reference numbers separated by exactly 200 may be substantially similar in form and function. The rig 210 may be provided in the form of a rig body 212 and a removably installable rig insert 214. The rig insert 214 may differ structurally from the cap 14, but the rig insert 214 may perform a similar function relative to the cap 14 in that the rig insert 214 may facilitate installation of the rig 210 in a fixed or semi-fixed position (e.g., along the fishing line 224) such that the rig body 212 is restricted or prevented from unintentionally moving or shifting while the rig 210 is in use.

The rig body 212 may be configured to receive at least a portion of a tube 216 (not shown) and/or a fishing line 224, and at least a portion of one or more leaders 218. The leader 218 may include one or more arms 228 supporting one or more bait keepers 230 and a midsection 233 arranged to be received within and/or coupled to an opening in the rig body 212. In the example of FIG. 14, the leader 218 may include a first and second arm 228A, 228B each supporting one bait keeper 230. In other embodiments, however, the leader 218 may include any number of arms 228 and any number of bait keepers 230 arranged in any suitable configuration. The bait keepers 230 may be substantially similar to the bait keepers 30 of the rig 10. For example, the bait keepers 230 may each include a tab 234 coupled to the leader 218 and an attachment member 236 coupled to the tab 234 and extending outwardly therefrom. However, in other embodiments, the bait keepers 230 may be provided in any suitable form.

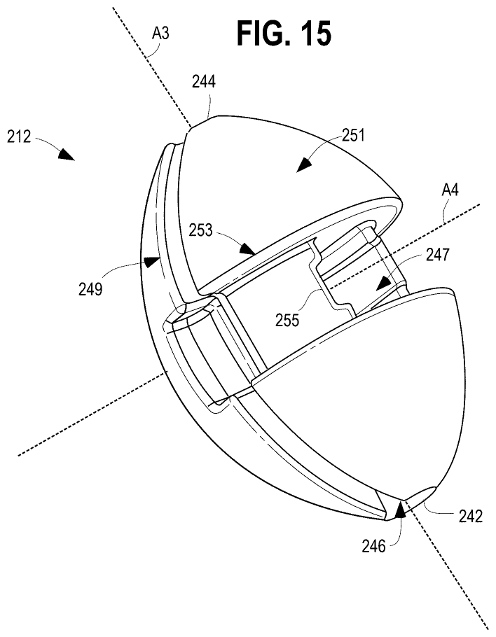

Turning to FIG. 15, the rig body 212 may include a main channel 246 configured to receive a portion of the tube 216 and/or the fishing line 224 and an insert cavity 247 configured to receive the rig insert 214. The main channel 246 may be provided in the form of a substantially circular or rounded opening extending entirely through the rig body 212 (e.g., extending between a rig body first end 242 and a rig body second end 244). The insert cavity 247 may be provided in the form of a substantially rectilinear opening extending entirely through the rig body 212 and oriented at an angle with respect to the main channel 246. For example, the main channel 246 may be defined by a third axis A3 extending linearly between the rig body first and second ends 242, 244, and the insert cavity 247 may extend through the rig body 212 along a fourth axis A4 oriented at an angle with respect to the third axis A3. In some embodiments, the third and fourth axes A3, A4 may be substantially perpendicular with respect to one another. In other embodiments, the third and fourth axes A3, A4 may be oriented at any suitable angle with respect to one another.

In some embodiments, the rig body 212 may include a trench 249 positioned along an outer shell 251 of the rig body 212 and extending inwardly therefrom. For example, the trench 249 may be provided in the form of a substantially rectilinear recess or carveout extending between the rig body first end 242 and the rig body second end 244. In some embodiments, the trench 249 may be an opening to the main channel 246 and may facilitate installation of the rig body 212 on the fishing line 224. For example, the trench 249 may enable a user to insert the rig body 212 onto the fishing line 224 without having to untie the knot securing the mainline lure. Additionally, the trench 249 may negate the need to thread the fishing line 224 through the main channel 246. Instead, using the trench 249, a user may directly install the rig body 212 in a desired location along the fishing line 224.

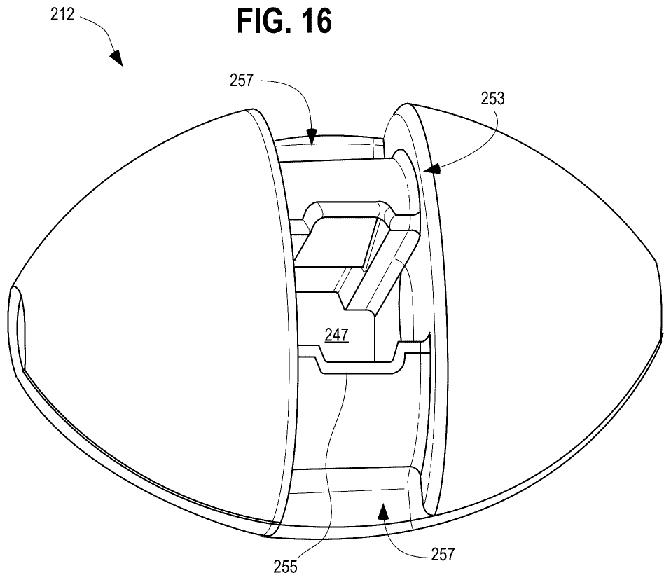

The rig body 212 may also include a receiving space 253 provided in the form of a substantially rectilinear recess or carveout positioned on the outer shell 251 and extending inwardly therefrom. The receiving space 253 may be positioned proximate or adjacent to an entry end 255 of the insert cavity 247. As best shown in FIG. 16, the receiving space 253 may extend across the outer shell 251 between two ledges 257 positioned on opposing ends of the receiving space 253. The receiving space 253 may be configured to receive or accommodate at least a portion of the rig insert 214 when the rig 210 is assembled.

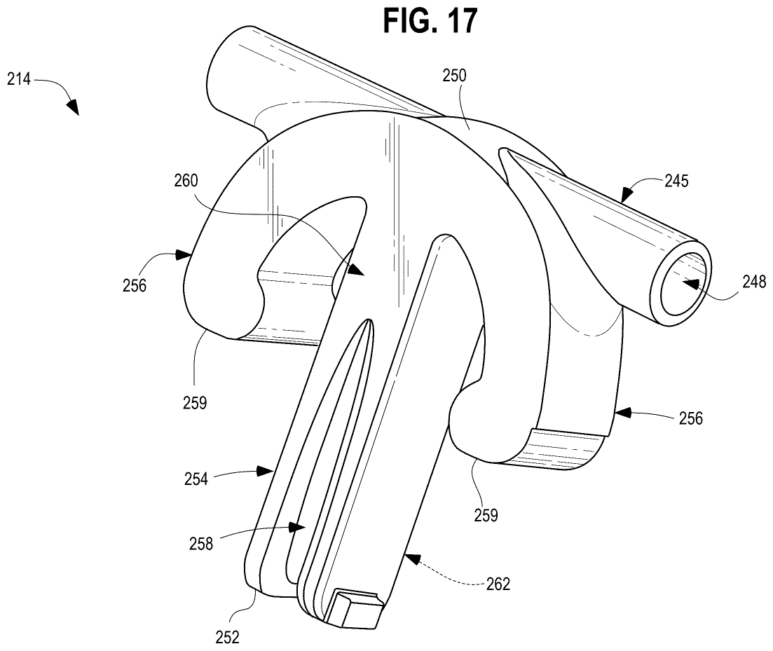

Turning to FIG. 17, the rig insert 214 may be defined by an apex 250 and an insert end 252 opposing the apex 250. The rig insert 214 may include a insert post 254 extending from the insert end 252 at least partially toward the apex 250, two insert arms 256 formed integrally with or coupled to the insert post 254 and extending outwardly therefrom, and a leader channel 248 positioned at or proximate to the apex 250. Each insert arm 256 may terminate at an insert arm terminal end 259 thereof. The leader channel 248 may be defined by a substantially tubular duct 245 extending outwardly from both sides of the apex 250 and oriented at an angle with respect to the insert post 254 (e.g., the duct 245 may be substantially perpendicular with respect to the insert post 254). However, in other embodiments, the leader channel 248 may be provided in other forms and may be positioned in any suitable location.

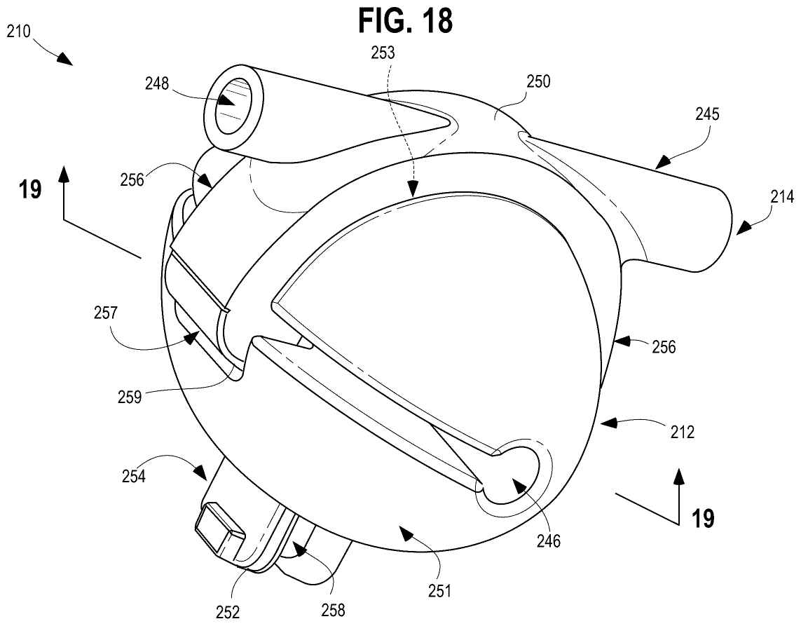

Turning to FIG. 18, the rig insert 214 may be installed on or coupled to the rig body 212 such that the insert post 254 is received within the insert cavity 247 and the insert arms 256 are received within the receiving space 253. For example, when the rig insert 214 is installed, the insert end 252 may extend entirely through the insert cavity 247 such that the insert end 252 extends beyond the outer shell 251 of the rig body 212. Additionally, when the rig insert 214 is installed, the insert arm terminal end 259 of each insert arm 256 may be in contact with or positioned adjacent to the associated ledge 257.

The insert post 254 may include an insert post recess 258 formed at the insert end 252 and extending at least partially toward the apex 250 along a first lateral face 260 and a second lateral face 262 of the insert post 254 (e.g., the second lateral face 262 is positioned opposite the first lateral face 260). For example, the insert post recess 258 may be provided in the form of a substantially linear carveout formed in the first and second lateral faces 260, 262 and extending inwardly therefrom, and at least a portion of the insert post recess 258 may be positioned at the insert end 252 and extend inwardly therefrom (e.g., toward the apex 250). The insert post recess 258 may be configured to receive or accommodate a portion of the tube 216 and/or the fishing line 224 when the rig insert 214 installed in the rig body 212 and the rig 210 is in use.

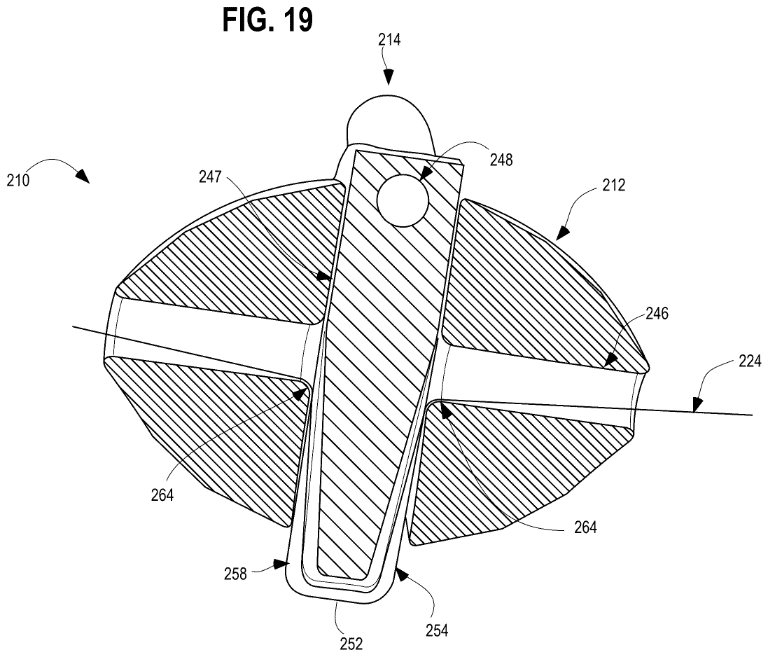

Turning to FIG. 19, the rig insert 214 may be configured to engage the fishing line 224 when the rig 210 is assembled. In particular, the insert post recess 258 may be configured to accommodate and/or engage a portion of the fishing line 224. To assemble the rig 210, the fishing line 224 may first be fed through the main channel 246. In some embodiments, the fishing line 224 may be positioned within the main channel 246 on its own. In other embodiments, the tube 216 may be utilized and positioned within the main channel 246, and the fishing line 224 may be fed through the tube 216. Either way, the rig insert 214 may be installed on the rig body 212 once the fishing line 224 is positioned within the main channel 246.

Thus, the insert post 254 may impact and engage the fishing line 224 as the rig insert 214 is installed. For example, as the rig insert 214 extends through the insert cavity 247, the insert end 252 may impact the fishing line 224 such that the fishing line 224 is received within the insert post recess 258 and forced to travel downwardly through the insert cavity 247 as installation of the rig insert 214 is completed. In this way, the rig insert 214 may apply a pinching force to the fishing line 224 or otherwise engage the fishing line 224 such that the fishing line 224 is restricted or prevented from shifting or moving within the main channel 246. For example, engagement with the insert post 254 may press the fishing line 224 against one or more adjacent corners or surfaces 264 of the rig body 212, thereby applying a pinching force to the fishing line 224 and restricting its movement relative to the rig body 212. In embodiments where the tube 216 is utilized, the insert post 254 may engage (e.g., pinch) the tube 216 in the same manner as described above with respect to the fishing line 224. In other embodiments, the rig insert 214 may engage the fishing line 224 in any suitable manner provided that the rig insert 214 is configured to restrict or prevent unintentional movement of the fishing line 224 while the rig 210 is in use.

The rig insert 214 may thus be configured to retain the rig body 212 in a fixed or semi-fixed position with respect to the fishing line 224 while the rig 210 is in use. To adjust the position of the rig 210, the rig insert 214 may be removed from the rig body 212 (e.g., thereby disengaging the fishing line 224), the rig body 212 may be repositioned along the fishing line 224, and the rig insert 214 may be re-installed on the rig body 212 (e.g., thereby reengaging the fishing line 224).

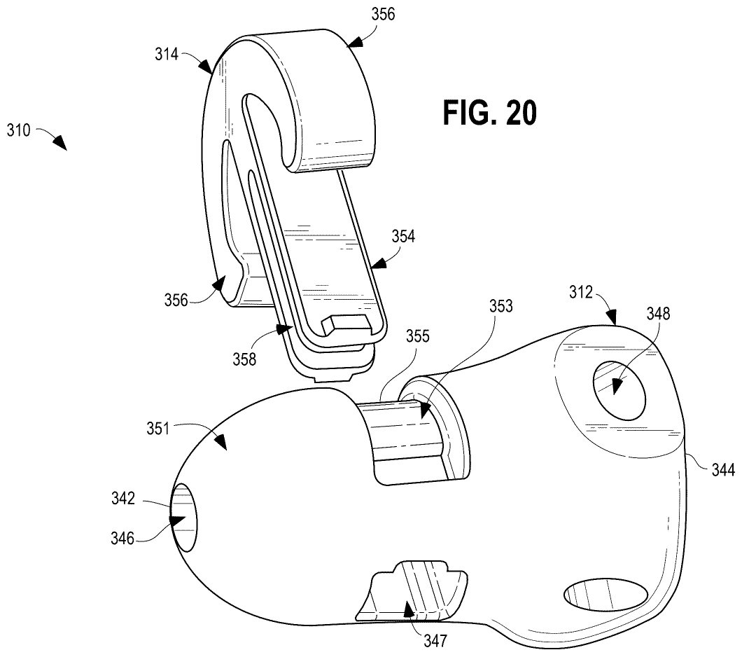

Turning to FIG. 20, a rig 310 may be substantially similar to the rig 210, and components of the rig 310 and the rig 210 that have similar names and reference numbers separated by exactly 100 may be substantially similar in form and function. The rig 310 may be provided in the form of a rig body 312 and a removably installable rig insert 314. The rig insert 314 may be substantially the same as the rig insert 214, except that the duct 245 may be omitted. Instead, the rig 310 may include a leader channel 348 positioned on the rig body 312 rather than the rig insert 314. The rig insert 314 may be removably installable on the rig body 312 in substantially the same manner as described above with respect to the rig body 212 and the rig insert 214.

The rig body 312 may include may be configured to receive at least a portion of a tube 316 and/or at least a portion of one or more leaders 318 (e.g., substantially similar to the tubes 116, 216 and leaders 118, 218). For example, the rig body 312 may include a main channel 346 extending entirely therethrough between a rig body first end 342 and a rig body second end 344, a leader channel 348 (e.g., positioned proximate to either the rig body first end 342 or the rig body second end 344) oriented at an angle with respect to the main channel 346, and an insert cavity 347 configured to receive the rig insert 314 when the rig 310 is assembled. The rig insert 314 may include an insert post 354 configured to extend into the insert cavity 347, two insert arms 356 arranged to be received by a receiving space 353 of the rig body 312 when the rig insert 314 is installed, and an insert post recess 358 configured to receive and/or engage a portion of the fishing line 324 when the rig 310 is assembled.

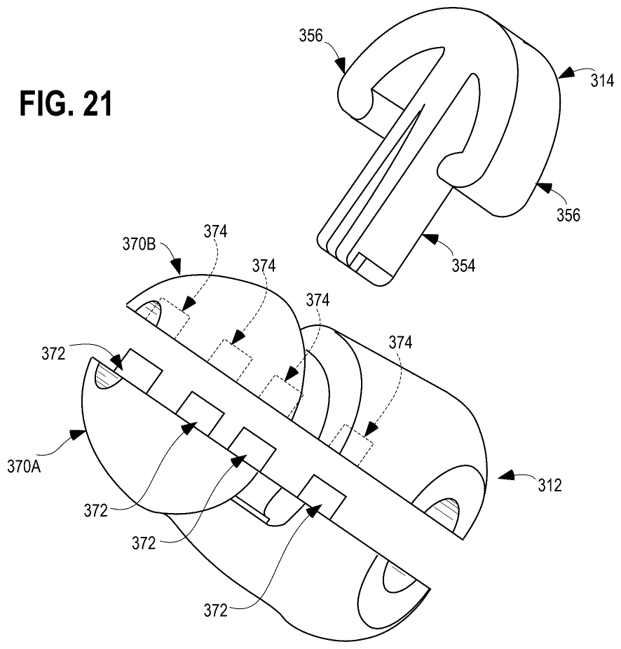

Turning to FIG. 21, in some embodiments, the rig body 312 may be include a rig body first portion 370A and a rig body second portion 370B. The rig body first and second portions 370A, 370B may be releasably coupled together in a snap fit, press fit, friction fit, or utilizing any other suitable coupling mechanism. For example, in some embodiments, the rig body first portion 370A may include one or more protrusions 372, and the rig body second portion 370B may include one or more associated openings 374 arranged to align with and receive the protrusions 372 when the rig body first and second portions 370A, 370B are pressed together. The openings 374 may receive the respective protrusions 372 in a snap fit, press fit, friction fit, etc. such that the rig body first and second portions 370A, 370B are releasably coupled together.

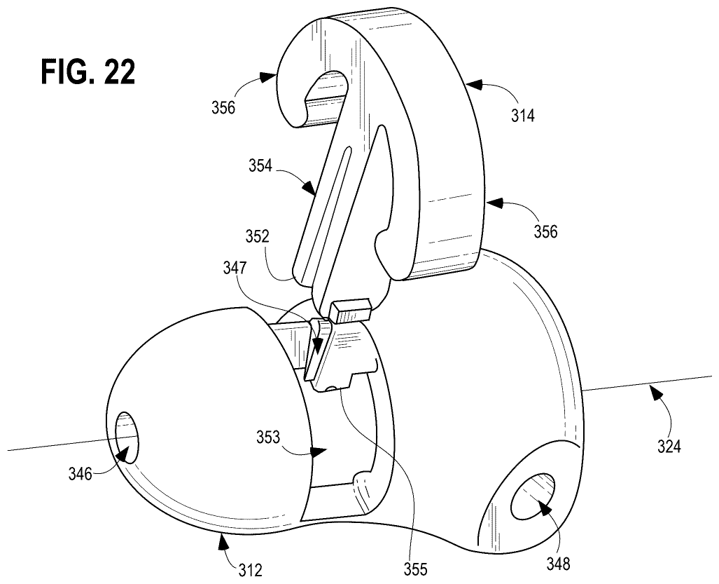

Turning to FIG. 22, the rig 310 may be assembled by coupling the rig insert 314 and the rig body 312 while the fishing line 324 extends through the main channel 346. Like the rig 210, the rig 310 may be used with a tube 316 configured to surround the fishing line 324 within the main channel 346 when the rig 310 is assembled. In other embodiments, such as the illustrated embodiment of FIG. 22, the tube 316 may be omitted and the fishing line 324 may be positioned within the main channel 346 alone. The fishing line 324 may be engaged or received by the insert post recess 358 when the rig insert 314 is installed in the rig body 312. In this way, the rig insert 314 may engage the fishing line 324 (e.g., by applying a pinching force thereto), thereby restricting or preventing the rig body 312 from unintentionally moving or shifting with respect to the fishing line 324.

When the rig 310 is assembled, the rig insert 314 may be received within the insert cavity 347. For example, an insert end 352 of the insert post 354 may extend into the insert cavity 347 via an entry end 355 thereof. A user may press the rig insert 314 into the insert cavity 347 until the insert post 354 extends entirely through the insert cavity 347 and the insert arms 356 are positioned within the receiving space 353.

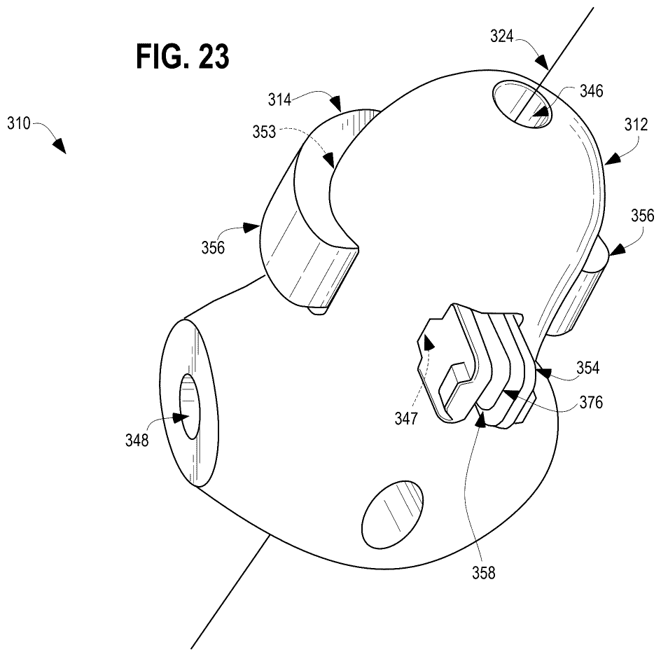

As best shown in FIG. 23, the insert end 352 of the insert post 354 may emerge out of the insert cavity 347 and beyond an outer shell 351 of the rig body 312 when the rig insert 314 is installed. An active portion 376 of the fishing line 324 may be retained or received by the insert post recess 358 such that the rig insert 314 applies a force (e.g., a friction, a pinching force, etc.) to the fishing line 324 when the rig 310 is in use.

Engagement between the rig insert 314 and the fishing line 324 (and/or engagement between the rig insert 314 and the tube 316) may restrict or inhibit the rig 310 from moving undesirably with respect to the fishing line 324 while in use. To adjust the positioning of the rig 310, the rig insert 314 may be removed from the insert cavity 347 (e.g., thereby disengaging the fishing line 324), the position of the rig body 312 with respect to the fishing line 324 may be adjusted, and the rig insert 314 may be reinstalled on the rig body 312 (e.g., thereby reengaging the fishing line 324).

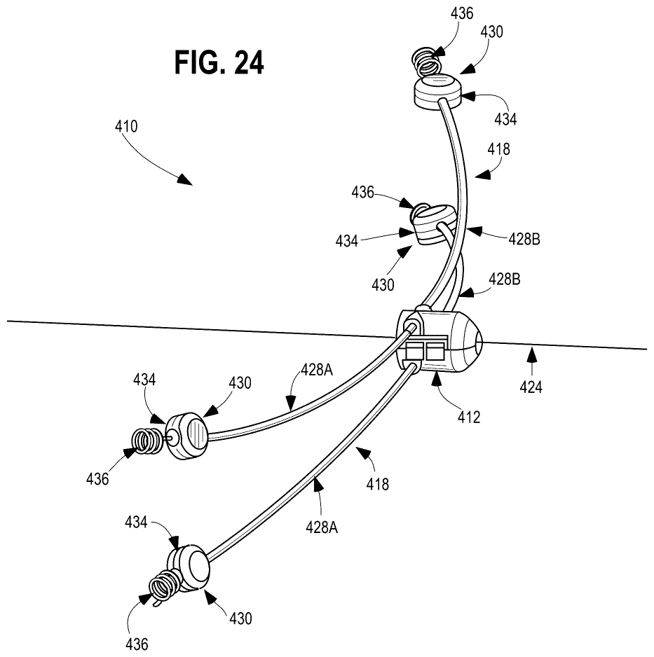

Turning to FIG. 24, a rig 410 may be substantially similar to the rig 10, and components of the rig 410 and the rig 10 that have similar names and reference numbers separated by exactly 400 may be substantially similar in form and function. The rig 410 may be provided in the form of a rig body 412 configured to support at least a portion of a tube 416 (not shown) and/or at least a portion of one or more leaders 418. However, as explained in detail below, the rig 410 may be designed for use without the tube 416.

The leaders 418 may be received within the leader channel 448. The leaders 418 may include one or more arms 428 supporting one or more bait keepers 430 and a midsection 433 arranged to be received within and/or coupled to an opening in the rig body 412. In the example of FIG. 24, the leaders 418 may each include a first and second arm 428A, 428B each supporting one bait keeper 430. In other embodiments, however, the leaders 418 may include any number of arms 428 and any number of bait keepers 430 arranged in any suitable configuration. In some embodiments, the bait keepers 430 may be substantially similar to the bait keepers 30 of the rig 10. For example, the bait keepers 430 may each include a tab 434 coupled to the leader 418 and an attachment member 436 coupled to the tab 434 and extending outwardly therefrom. However, in other embodiments, the bait keepers 430 may be provided in any suitable form.

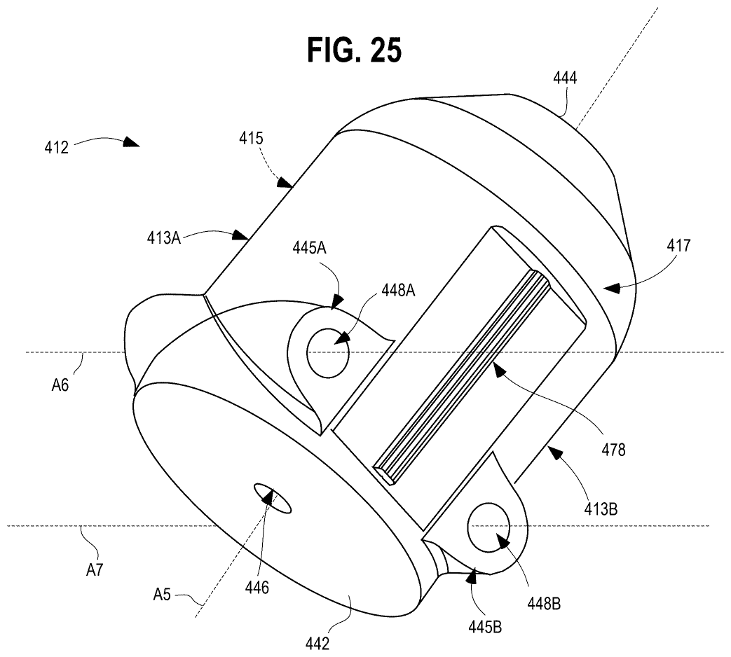

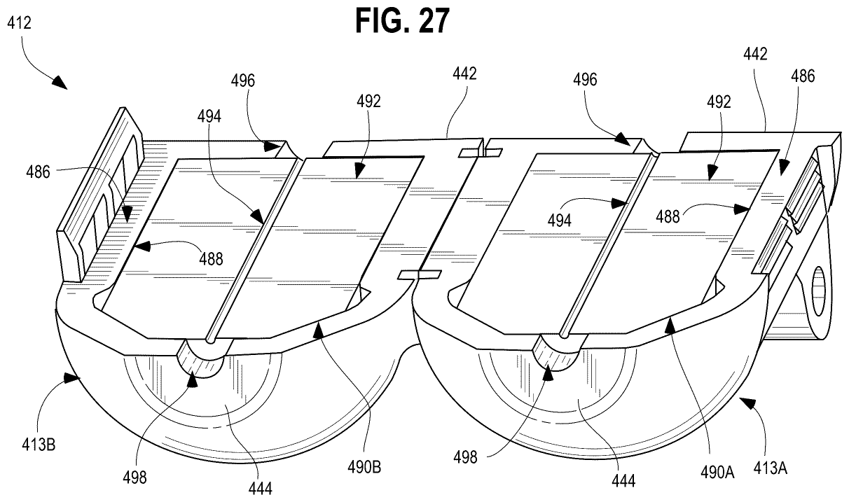

Turning to FIG. 25, the rig body 412 may be provided in the form of a first rig body portion 413A adjustably coupled to a second rig body portion 413B. Each of the first and second rig body portion 413A, 413B may be defined by a rig body first side 415 and a rig body second side 417 opposing the rig body first side 415. In some embodiments, the first and second rig body portions 413A, 413B may be hingedly coupled to one another via a hinge 478 positioned at or proximate to the rig body second side 417. Thus, the rig body 412 may be movable between a closed position (e.g., depicted in FIG. 25) and an open position (e.g., depicted in FIG. 27) by rotating the first and second rig body portions 413A, 413B relative to one another about the hinge 478.

The rig body 412 may include a main channel 446 extending between a rig body first end 442 and a rig body second end 444. The main channel 446 may be configured to receive and/or retain the fishing line 424 and/or the tube 416 when the rig 410 is in use. The rig body 412 may also include one or more leader channels 448 configured to receive and/or retain the leaders 418. For example, the leader channels 448 may be defined by a tubular duct 445 provided in substantially the same form as the duct 245 of the rig 210. The tubular ducts 445 may be formed integrally with the rig body 412 or may be coupled thereto. In the illustrated embodiment, the rig body 412 may include two ducts 445 defining two leader channels 448, with a first duct 445A defining a first leader channel 448A positioned on the first rig body portion 413A and a second duct 445B defining a second leader channel 448B positioned on the second rig body portion 413B. However, in other embodiments, the rig body 412 may include any number of leader channels 448 provided in any suitable form and positioned in any suitable location. For example, in some embodiments, the ducts 445 may be omitted and the leader channels 448 may be provided in the form of openings extending through the rig body 412.

In some embodiments, the main channel 446 and the leader channels 448 may be oriented at an angle with respect to one another. For example, the main channel 446 may be defined by a fifth axis A5 extending linearly between the rig body first and second ends 442, 444, the first leader channel 448A may be defined by a sixth axis A6 extending linearly through the first duct 445A, and the second leader channel 448B may be defined by a seventh axis A7 extending linearly through the second duct 445B. In some embodiments, the sixth and seventh axes A6, A7 may be substantially parallel with respect to one another, and the fifth axis A5 may be substantially perpendicular with respect to the sixth and seventh axes A6, A7. In other embodiments, the sixth and seventh axes A6, A7 may be oriented at any angle with respect to one another, and the fifth axis A5 may be oriented at any angle with respect to the sixth axis A6 and/or the seventh axis A7.

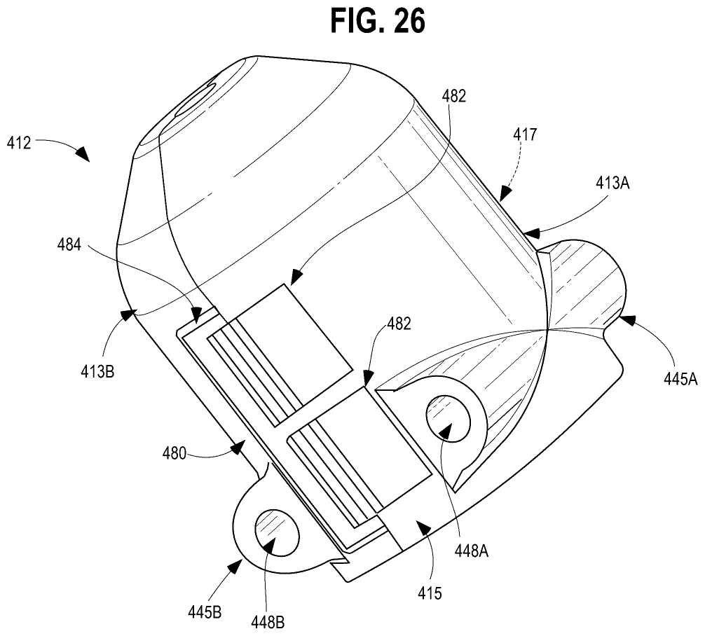

As best shown in FIG. 26, the rig body 412 may include a closure mechanism 480 positioned opposite the hinge 478 (e.g., positioned at or proximate to the rig body first side 415). For example, in some embodiments, the closure mechanism 480 may be provided in the form of a clasp or other similar mechanism including one or more male components 482 positioned on the first rig body portion 413A and arranged to be received (e.g., in a snap fit or other type of fit) by one or more female components 484 positioned on the second rig body portion 413B. Thus, when the male components 482 are received by the female components 484, the rig body 412 may be secured in the closed position. However, in other embodiments, the closure mechanism 480 may be provided in any other suitable form (e.g., the closure mechanism 480 may be a latch, snap fastener, magnetic closure, buckle, hook and loop, spring clip, or other mechanism), provided that the closure mechanism 480 is configured to secure the rig body 412 in the closed position.

Turning to FIG. 27, the rig body 412 is depicted in the open position. In some embodiments, the first and second rig body portions 413A, 413B may each be provided in the form of a casing 486 having an interior perimeter 488 that defines a hollow space positioned within the first and second rig body portions 413A, 413B, respectively. Thus, a first grip member 490A may be positioned within the hollow space defined by the casing 486 of the first rig body portion 413A, and a second grip member 490B may be positioned within the hollow space defined by the casing 486 of the second rig body portion 413B. The first and second grip members 490A, 490B may be configured to grip or apply a force (e.g., a pinching force or a friction) to the fishing line 424 when the rig 410 is in use. For example, the first and second grip members 490A, 490B may be formed from a thermoplastic elastomer (TPE), silicone rubber, neoprene, nitrile rubber, polyurethane, or other suitable materials, provided that the first and second grip members 490A, 490B are configured to prevent or restrict undesirable movement or shifting of the fishing line 424 when the rig 410 is in use.

Each of the first and second grip members 490A, 490B may include a substantially planar mating surface 492 (e.g., arranged to be substantially coplanar with an adjacent surface of the associated casing 486) and may define a portion of a substantially cylindrical fishing line channel 494 provided in the form of a linear recess formed in the mating surfaces 492 and extending between the rig body first and second ends 442, 444. Additionally, the first and second rig body portions 413A, 413B may each define a portion of a first fishing line opening 496 positioned at the rig body first end 442 and a second fishing line opening 498 positioned at the rig body second end 444.

When the rig body 412 is in the closed position, the mating surfaces 492 may be adjacent to or in contact with one another. The first fishing line opening 496, second fishing line opening 498, and fishing line channel 494 may be in communication with one another such that the fishing line 424 may extend therethrough. In other words, together, the first fishing line opening 496, second fishing line opening 498, and fishing line channel 494 may constitute the main channel 446 described above with reference to FIG. 25. In some embodiments, the rig 410 may be designed for use without the tube 416 in that the fishing line channel 494 may be imparted with a sufficiently small size or diameter that, when the fishing line 424 alone is positioned within the fishing line channel 494, the first and second grip members 490A, 490B may contact and engage the fishing line (e.g., by applying a friction or a pinching force thereto).

To use the rig 410, a user may first place the rig body 412 in the open position. The rig body 412 may then be positioned at a desired location along the fishing line 424, the fishing line 424 may be aligned with the fishing line channel 494 of one of the first and second grip members 490A, 490B, and the rig body 412 may be transitioned to the closed position such that the fishing line channel 494 receives the fishing line 424 and the first and second grip members 490A, 490B grip or engage the portion of the fishing line 424 positioned within the fishing line channel 494. Engagement between the first and second grip members 490A, 490B may prevent or restrict the rig body 412 from unintentionally moving or shifting with respect to the fishing line 424 while the rig 410 is in use. The one or more leaders 418 may be installed within the respective leader channel 448 either before or after installing the rig body 412 on the fishing line 424, and lures may subsequently be coupled to the bait keepers 430. To adjust the position of the rig 410, the rig body 412 may be transitioned to the open state, moved to a desired location along the fishing line 424, and then installed in the desired location as described above.

As is evident from the foregoing description, certain aspects of the present disclosure are not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations and other uses in applications which do not depart from the spirit and scope of the present disclosure are deemed to be covered by the invention which is limited only by the claims which follow.

What is claimed is:

1. A rig for attaching one or more lures to a fishing line, the rig comprising:
a rig body including:
a main channel configured to receive a portion of the fishing line; and
at least one leader channel configured to receive at least a portion of at least one leader, the at least one leader designed to retain the one or more lures;
an insert configured to be at least partially received within the main channel and designed to restrict movement of the rig body relative to the fishing line when the rig is in use,
wherein engagement between the rig body and the insert applies a pinching force to the fishing line.

2. The rig of claim 1, wherein the at least one leader further comprises:
a first arm having a first bait keeper positioned at an end thereof;
a second arm having a second bait keeper positioned at an end thereof; and
a midsection positioned between the first arm and the second arm, the midsection designed to be received within the leader channel when the rig is in use.

3. The rig of claim 1, wherein the insert is provided in the form of a cap, the cap further comprising:
a cap body;
a cap insert positioned on the cap body and extending outwardly therefrom; and
a cap channel extending through the cap body and the cap insert, the cap channel designed to receive a portion of the fishing line when the rig is in use.

4. The rig of claim 3, wherein the cap insert has a tapered geometry such that:
the cap insert is defined by a first thickness at an insert proximal end;
the cap insert is defined by a second thickness at an insert distal end; and
the first thickness is greater than the second thickness.

5. The rig of claim 3, further comprising a tube designed to encompass a portion of the fishing line and to be at least partially received by the cap channel and the main channel.

6. The rig of claim 5, wherein the tube includes a flared end designed to engage the cap body and restrict the tube from being pulled through the cap channel.

7. The rig of claim 5, wherein the cap engages the tube when the cap insert is received within the main channel, and wherein engagement between the cap and the tube applies a pinching force to the fishing line.

8. A rig for attaching one or more lures to a fishing line, comprising:
a rig body including a main channel extending entirely therethrough and configured to receive a portion of the fishing line; and
an engagement mechanism associated with the rig body, the engagement mechanism designed to be positioned at least partially within the main channel when the rig is assembled,
wherein the rig is configured to be selectively positioned in a desired location along the fishing line, and
wherein the engagement mechanism engages the fishing line to restrict movement of the rig relative to the fishing line during use.

9. The rig of claim 8, wherein:
the engagement mechanism is provided in the form of a cap including a cap insert, and
wherein the main channel is designed to receive at least a portion of the cap insert in a press fit, a snap fit, or a friction fit.

10. The rig of claim 8, wherein:
the engagement mechanism is provided in the form of a roller including a stud that is received within a guide track formed in the rig body, and
wherein changing a position of the roller relative to the rig body changes a pinching force applied by the roller to the fishing line.

11. The rig of claim 8, wherein:
the rig body further comprises a rig cavity in communication with the main channel, and
the engagement mechanism is provided in the form of a rig insert including an insert post designed to be at least partially received within the rig cavity when the rig is assembled, the rig insert further including a leader channel designed to receive a portion of a leader that supports the one or more lures.

12. The rig of claim 11, wherein the insert post includes a recess designed to receive and accommodate a portion of the fishing line when the rig insert is installed on the rig body.

13. The rig of claim 8, wherein the rig body further comprises a first portion and a second portion designed to be releasably coupled together.

14. The rig of claim 13, wherein:
the first portion includes one or more protrusions, and
the second portion includes one or more openings arranged to align with the one or more protrusions and designed to receive the one or more protrusions in a press fit, a snap fit, or a friction fit.

15. The rig of claim 13, wherein the first portion and the second portion are pivotably coupled together via a hinge.

16. The rig of claim 15, wherein the first portion and the second portion may be secured in a closed position via a closure mechanism when the rig is in use.

17. The rig of claim 15, further comprising:
a first leader channel extending through the first portion, the first leader channel designed to receive a portion of a first leader that supports two or more lures; and
a second leader channel extending through the second portion, the second leader channel designed to receive a portion of a second leader that supports two or more lures.

18. The rig of claim 15, wherein:
the first portion includes a first grip member designed to restrict movement of the rig body relative to the fishing line when the rig is in use, and
the second portion includes a second grip member designed to restrict movement of the rig body relative to the fishing line when the rig is in use.

19. The rig of claim 18, wherein:
the first portion includes a casing defining a first hollow space that accommodates the first grip member,
the second portion includes a casing defining a second hollow space that accommodates the second grip member, and
the first grip member and the second grip member are each formed from a material selected from a list comprising: a thermoplastic elastomer, silicone rubber, neoprene, nitrile rubber, and polyurethane.

20. A method for attaching one or more lures to a fishing line, comprising:
positioning a tube around a portion of the fishing line;
positioning the tube and the fishing line at least partly within a main channel of a rig body that supports the one or more lures; and
actuating an engagement mechanism associated with the rig body, the engagement mechanism designed to be at least partially positioned within the main channel,
wherein engagement between the rig body, the engagement mechanism, the tube, and the fishing line restricts movement of the rig body relative to the fishing line during use.
